(19) United States
(12) Patent Application Publication
(10) Pub. No.: US 2026/0111721 A1
(43) Pub. Date: Apr. 23, 2026

(54) DYNAMIC SPARSITY-AWARE PARAMETER-EFFICIENT FINE-TUNING (PEFT) FOR LARGE LANGUAGE MODELS

(71) Applicant: QUALCOMM Incorporated, San Diego, CA (US)

(72) Inventors: Kyuhong SHIM, Seoul (KR); Yunseong LEE, Gimpo-si (KR); Minseop PARK, San Diego, CA (US); Wonguk CHO, Suwon (KR)

(21) Appl. No.: 18/886,804

(22) Filed: Sep. 16, 2024

(51) Int. Cl. G06N 3/08

(52) U.S. Cl. CPC G06N 3/08

(57) ABSTRACT

A processor-implemented method of dynamic sparsity-aware parameter-efficient fine-tuning for an artificial neural network (ANN) includes receiving the ANN having a plurality of pre-trained weights and one or more adapters. Each adapter is configured for a specific task. A sparsity of adapter parameters for each of the one or more adapters is adapted based on a predictor threshold for each layer of the adapter and the ANN.

### FIELD OF THE DISCLOSURE

Aspects of the present disclosure generally relate to artificial neural networks, and more specifically to dynamic sparsity-aware parameter-efficient fine-tuning for large language models.

### BACKGROUND

Artificial neural networks may comprise interconnected groups of artificial neurons (e.g., neuron models). The artificial neural network (ANN) may be a computational device or be represented as a method to be performed by a computational device. Convolutional neural networks (CNNs), and transformers are types of feed-forward and attention-based ANNs, respectively. Artificial neural networks may include collections of neurons that each have a receptive field and that collectively tile an input space. Artificial neural networks, such as deep convolutional neural networks (DCNs), have numerous applications. In particular, these neural network architectures are used in various technologies, such as image recognition, image generation, text generation, video generation, speech recognition, audio generation, natural language processing, acoustic scene classification, keyword spotting, autonomous driving, extended reality (XR), camera/video, and other tasks.

Image generation and video generation may be performed with generative artificial intelligence (AI) models. Adapting these large models towards a new application is computationally intensive. Adaptation of the models generally specifies training/fine-tuning portions of the large model. It would be desirable to more efficiently fine-tune generative AI models.

### SUMMARY

Some aspects of the present disclosure are directed to an apparatus. The apparatus has a memory and one or more processors coupled to the memory. The processor(s) is configured to receive an artificial neural network (ANN) having a number of pre-trained weights and one or more adapters. Each adapter is configured for a specific task. The processor(s) is still further configured to adapt a sparsity of adapter parameters for each of the one or more adapters based on a predictor threshold for each layer of the adapter and the ANN.

In various aspects of the present disclosure, a processor-implemented method performed by one or more processors includes receive an artificial neural network (ANN) having a number of pre-trained weights and one or more adapters. Each adapter is configured for a specific task. The processor-implemented method still further includes adapt a sparsity of adapter parameters for each of the one or more adapters based on a predictor threshold for each layer of the adapter and the ANN.

Various aspects of the present disclosure are directed to an apparatus. The apparatus includes means for receive an artificial neural network (ANN) having a number of pre-trained weights and one or more adapters. Each adapter is configured for a specific task. The apparatus further includes means for adapt a sparsity of adapter parameters for each of the one or more adapters based on a predictor threshold for each layer of the adapter and the ANN.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor in accordance with certain aspects of the present disclosure.

FIGS. 2A, 2B, and 2C are diagrams illustrating a neural network in accordance with various aspects of the present disclosure.

FIG. 2D is a diagram illustrating an exemplary deep convolutional network (DCN) in accordance various with aspects of the present disclosure.

FIG. 3A is a block diagram illustrating an exemplary deep convolutional network (DCN) in accordance with various aspects of the present disclosure.

FIG. 3B is a block diagram illustrating an example transformer encoder block, in accordance with various aspects of the present disclosure.

FIG. 4 is a block diagram illustrating an exemplary software architecture that may modularize artificial intelligence (AI) functions, in accordance various with aspects of the present disclosure.

FIG. 5 is a block diagram illustrating low rank adaptation (LoRA) of a generative artificial intelligence (AI) model.

FIG. 6 is a block diagram illustrating multi-adapter low rank adaptation (LoRA) of a generative artificial intelligence (AI) model.

FIG. 7 is a block diagram illustrating an example architecture for dynamic sparsity-aware parameter-efficient fine-tuning (PEFT) of a large language model (LLM), in accordance with various aspects of the present disclosure.

FIG. 8 is a block diagram illustrating an example architecture for dynamic sparsity-aware parameter-efficient fine-tuning (PEFT) of a large language model (LLM), in accordance with various aspects of the present disclosure.

FIG. 9 is a block diagram illustrating an example device for dynamic sparsity-aware parameter-efficient fine-tuning (PEFT) of a large language model (LLM) in accordance with various aspects of the present disclosure.

FIG. 10 is a flow diagram illustrating a processor-implemented method for implementing dynamic sparsity-aware parameter-efficient fine-tuning (PEFT) for an artificial neural network, in accordance with various aspects of the present disclosure.

### DETAILED DESCRIPTION

The detailed description set forth below, in connection with the appended drawings, is intended as a description of various configurations and is not intended to represent the only configurations in which the concepts described may be practiced.

The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks, and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Text generation, language generation, image generation, and video generation may be performed with generative artificial intelligence (AI) models. These models have many applications in autonomous driving, camera/video technology, extended reality (XR), augmented reality (AR), virtual reality (VR), etc. Adapting these large models to a new application is computationally intensive. Adaptation of the models generally specifies training/fine-tuning portions of the large model. Differing applications may include style transfer into multiple concepts/effects for vision models, as well as translation, common sense reasoning, and math for language models, for example.

Recently, some conventional approaches aiming to reduce the latency in large language models (LLMs) have proposed techniques to utilize dynamic sparsity.

Dynamic sparsity involves using the characteristics of rectifier linear unit (ReLU) activation functions in feed-forward (FF) modules of the underlying transformer, which make up the LLM. Parameters that correspond to zeroed-out elements (neurons) may be skipped and not loaded from memory.

Some of the latency of LLM inference stems from a memory input/output (I/O) bottleneck resulting from limited bandwidth in loading parameters from memory, for example.

Dynamic sparsity leverages a lightweight predictor that indicates zero elements. A low rank predictor may predict which elements (neurons) may be zero after ReLU. The low rank predictor may comprise a lightweight auxiliary network including a low rank bottleneck layer that has very few parameters (significantly less than the original projection layer). The low rank predictor may apply a sigmoid function to restrict the output to a value between zero and one. The output may indicate the importance of each element.

The low rank predictor may apply a threshold (e.g., 0.5), which may serve as a binary mask that indicates which elements (e.g., parameters) are valid. The binary mask may selectively determine which elements may be effective after ReLU activations. Then, only selected elements may be loaded once from memory to reduce prediction layers parameter budgets, for instance. When the predictor is successful (e.g., high accuracy in identifying important elements), the performance may be substantially similar to that of the original model while only loading the selected elements (e.g., parameters) rather than all of the parameters.

However, low rank adapters (LoRA) may use as many activated elements as possible to increase, or in some cases maximize, performance. The low rank predictor may initially be jointly trained with the original feed-forward network (FFN) (e.g., the FFN prior to adaptation with dynamic sparsity). When the LoRA is applied, the output of LoRA is added to the prediction of the original up-projection and thus may change the elements that may be zeroed out. In turn, the predictor's predictions may be less accurate. A tradeoff may be seen by exploring two extreme cases. In a first case, if the LoRA uses all elements, the accuracy is improved but the network may suffer reduced efficiency because all of the parameters are loaded from memory. On the other hand, in a second case, if the LoRA uses only elements predicted to be non-zero, the efficiency may be improved but the accuracy may be reduced.

To address these and other challenges, aspects of the present disclosure are directed to layer-wise progressive thresholding. Temporal resources may be re-allocated to focus more on a current context based on a user's gesture guidance, for example.

Particular aspects of the subject matter described in this disclosure can be implemented to realize one or more of the following potential advantages.

Enabling parameter-efficient fine-tuning (PEFT) for dynamic sparsity LLM takes both efficiency and tuning capability. The disclosed techniques may improve training stability and robustness. Additionally, the disclosed techniques may enable on-device LLM use cases, as on-device applications need both memory bandwidth reduction and personalization or customization using various adapters. Furthermore, the disclosed techniques may reduce memory consumption and context switching costs because only the predictor threshold is changed so only the LoRA may change for different tasks.

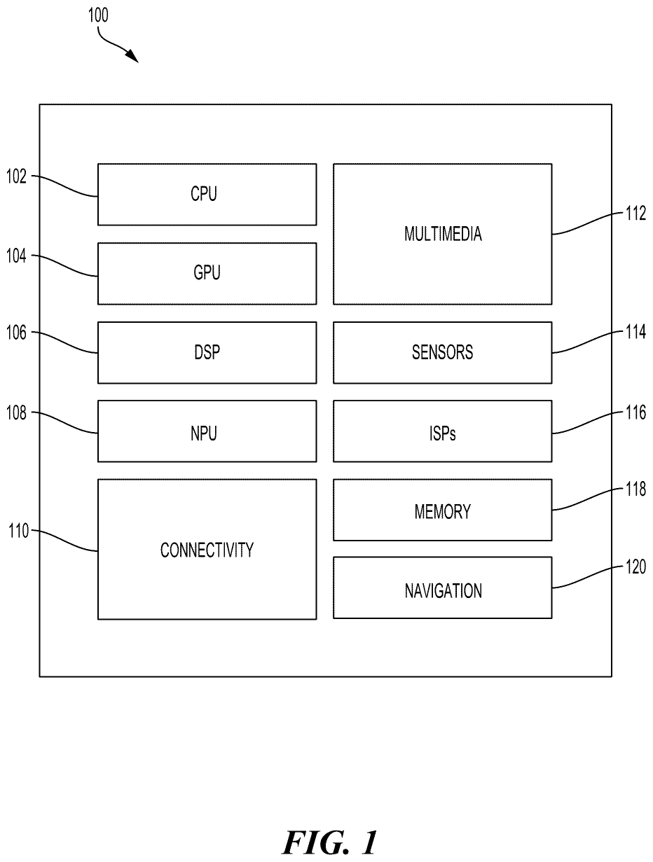

FIG. 1 illustrates an example implementation of a system-on-a-chip (SOC) 100, which may include a central processing unit (CPU) 102 or a multi-core CPU configured for dynamic sparsity-aware parameter-efficient fine-tuning of generative AI models. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from the memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM, RISC-V (RISC-five), or any reduced instruction set computing (RISC) architecture. In aspects of the present disclosure, the instructions loaded into the general-purpose processor 102 may include code to receive an artificial neural network (ANN) having a plurality of pre-trained weights and one or more adapters. Each adapter is configured for a specific task. The general-purpose processor 102 may also include code to adapt a sparsity of adapter parameters for each of the one or more adapters based on a predictor threshold for each layer of the adapter and the ANN.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

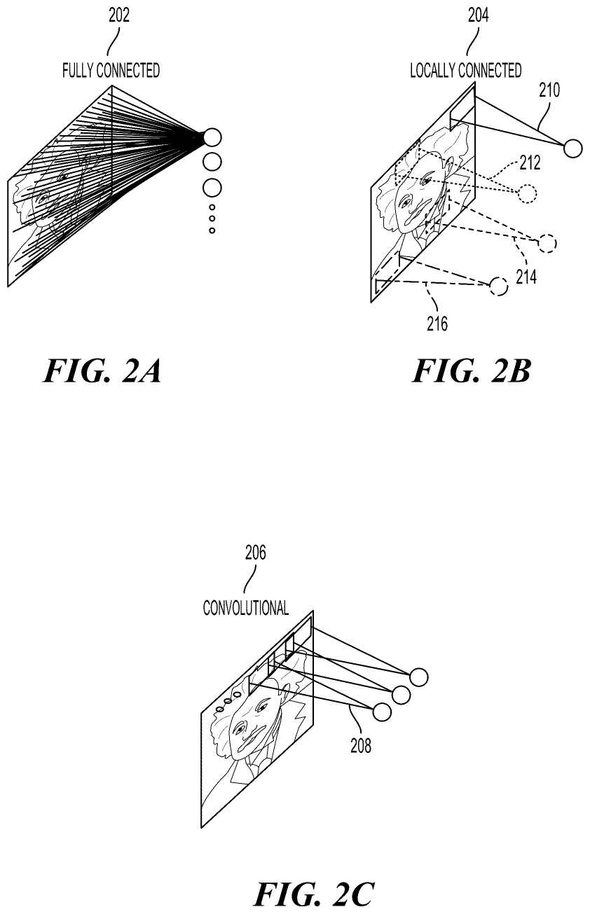

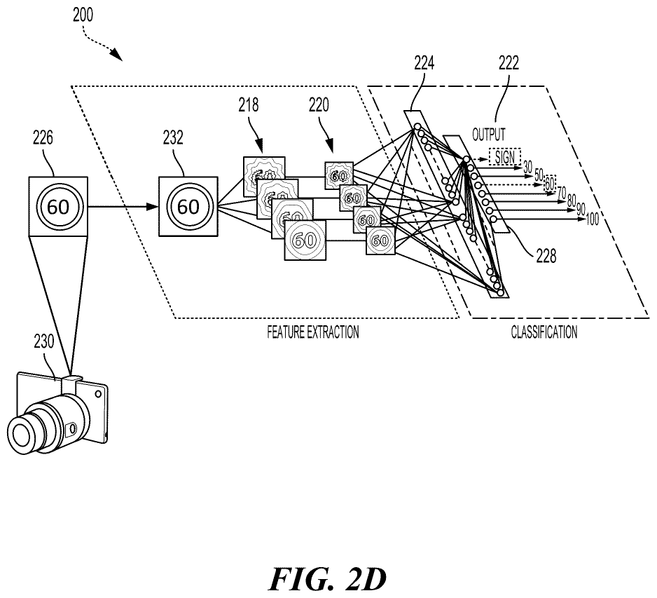

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

Although the present application applies to convolutional and linear layers, as well as transformer networks, an example will be described with respect to one type of convolutional neural network that is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 may be a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 may likely be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN 200 may be presented with new images (e.g., the speed limit sign of the image 226) and a forward pass through the DCN 200 may yield an output 222 that may be considered an inference or a prediction of the DCN 200.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

DCNs are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max(0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

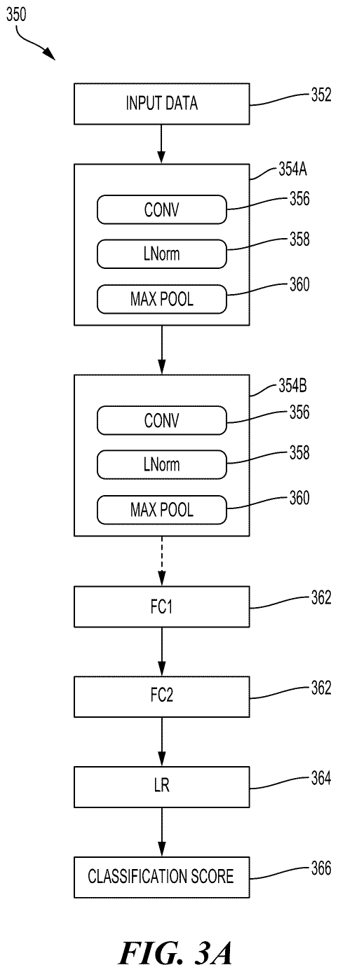

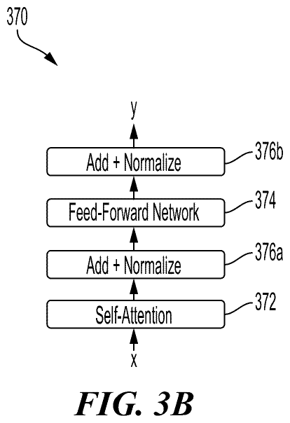

FIG. 3A is a block diagram illustrating a DCN 350. The DCN 350 may include multiple different types of layers based on connectivity and weight sharing. As shown in FIG. 3A, the DCN 350 includes the convolution blocks 354A, 354B. Each of the convolution blocks 354A, 354B may be configured with a convolution layer (CONV) 356, a normalization layer (LNorm) 358, and a max pooling layer (MAX POOL) 360.

Although only two of the convolution blocks 354A, 354B are shown, the present disclosure is not so limiting, and instead, any number of the convolution blocks 354A, 354B may be included in the DCN 350 according to design preference.

The convolution layers 356 may include one or more convolutional filters, which may be applied to the input data to generate a feature map. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a CPU 102 or GPU 104 of an SOC 100 (e.g., FIG. 1) to achieve high performance and low power consumption. In alternative embodiments, the parallel filter banks may be loaded on the DSP 106 or an ISP 116 of an SOC 100. In addition, the DCN 350 may access other processing blocks that may be present on the SOC 100, such as sensor processor 114 and navigation module 120, dedicated, respectively, to sensors and navigation.

The DCN 350 may also include one or more fully connected layers 362 (FC1 and FC2). The DCN 350 may further include a logistic regression (LR) layer 364. Between each layer 356, 358, 360, 362, 364 of the DCN 350 are weights (not shown) that are to be updated. The output of each of the layers (e.g., 356, 358, 360, 362, 364) may serve as an input of a succeeding one of the layers (e.g., 356, 358, 360, 362, 364) in the DCN 350 to learn hierarchical feature representations from input data 352 (e.g., images, audio, video, sensor data and/or other input data) supplied at the first of the convolution blocks 354A. The output of the DCN 350 is a classification score 366 for the input data 352. The classification score 366 may be a set of probabilities, where each probability is the probability of the input data including a feature from a set of features.

FIG. 3B is a block diagram illustrating an example transformer encoder block 370, in accordance with various aspects of the present disclosure. As shown in FIG. 3B, the example transformer encoder block 370 includes alternating layers of self-attention blocks 372 and feed-forward network (FFN) blocks 374. Normalization blocks 376 (e.g., 376a, 376b) may be applied after every block (e.g., 372, 374) of the example transformer encoder block 370. The transformer encoder block 370 may comprise an encoder block of a large scale model such as a large language model (LLM), for example. The LLM may include numerous transformer encoder blocks 370 and may be applied to tasks such as processing sequence data, for instance.

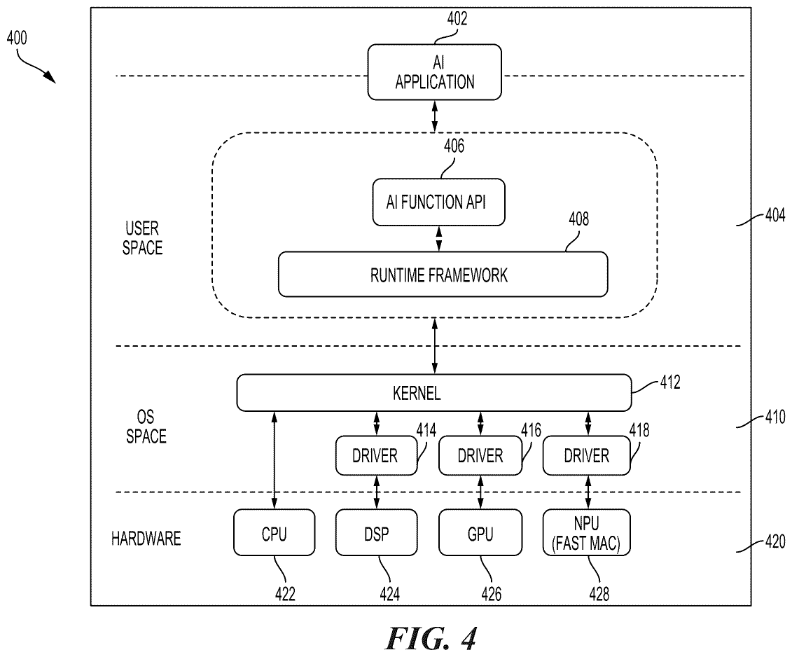

FIG. 4 is a block diagram illustrating an exemplary software architecture 400 that may modularize artificial intelligence (AI) functions. Using the architecture 400, applications may be designed that may cause various processing blocks of an SOC 420 (for example a CPU 422, a DSP 424, a GPU 426 and/or an NPU 428) (which may be similar to SOC 100 of FIG. 1) to support dynamic sparsity-aware parameter-efficient fine-tuning for an AI application 402, according to aspects of the present disclosure. The architecture 400 may, for example, be included in a computational device, such as a smartphone.

The AI application 402 may be configured to call functions defined in a user space 404 that may, for example, provide for the detection and recognition of a scene indicative of the location at which the computational device including the architecture 400 currently operates. The AI application 402 may, for example, configure a microphone and a camera differently depending on whether the recognized scene is an office, a lecture hall, a restaurant, or an outdoor setting such as a lake. The AI application 402 may make a request to compiled program code associated with a library defined in an AI function application programming interface (API) 406. This request may ultimately rely on the output of a deep neural network configured to provide an inference response based on video and positioning data, for example.

The run-time engine 408, which may be compiled code of a runtime framework, may be further accessible to the AI application 402. The AI application 402 may cause the run-time engine 408, for example, to request an inference at a particular time interval or triggered by an event detected by the user interface of the AI application 402. When caused to provide an inference response, the run-time engine 408 may in turn send a signal to an operating system in an operating system (OS) space 410, such as a Kernel 412, running on the SOC 420. In some examples, the Kernel 412 may be a LINUX Kernel. The operating system, in turn, may cause a continuous relaxation of quantization to be performed on the CPU 422, the DSP 424, the GPU 426, the NPU 428, or some combination thereof. The CPU 422 may be accessed directly by the operating system, and other processing blocks may be accessed through a driver, such as a driver 414, 416, or 418 for, respectively, the DSP 424, the GPU 426, or the NPU 428. In the exemplary example, the deep neural network may be configured to run on a combination of processing blocks, such as the CPU 422, the DSP 424, and the GPU 426, or may be run on the NPU 428.

Text generation, language generation, image generation, and video generation may be performed with generative artificial intelligence (AI) models. These models have many applications in autonomous driving, camera/video technology, extended reality (XR), augmented reality (AR), virtual reality (VR), etc. Adapting these large models to a new application is computationally intensive. Adaptation of the models generally specifies training/fine-tuning portions of the large model. Differing applications may include style transfer into multiple concepts/effects for vision models, as well as translation, common sense reasoning, and math for language models, for example.

Low rank adaptation (LoRA) is an established method for fine-tuning large generative artificial intelligence (AI) models towards new tasks. With LoRA, adapters can be analytically fused into base model weights, thus eliminating additional overhead during inference.

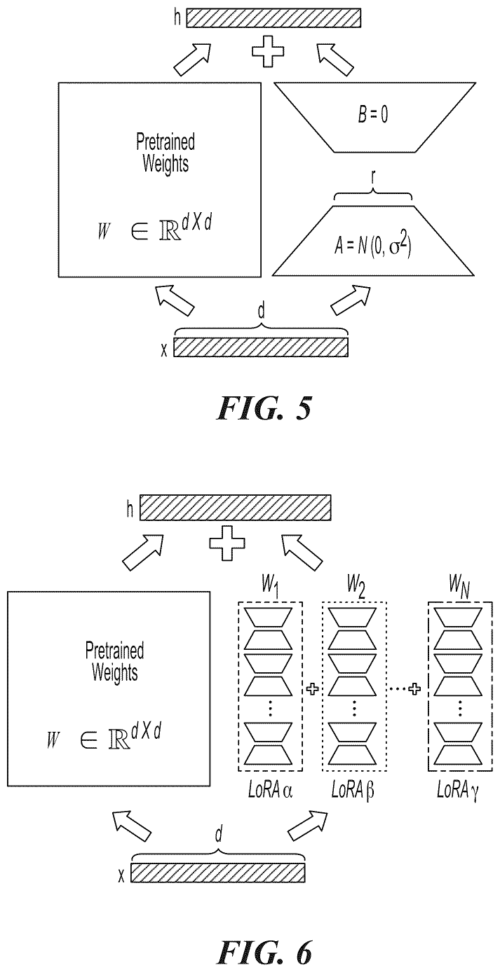

FIG. 5 is a block diagram illustrating low rank adaptation (LoRA) of a generative artificial intelligence (AI) model. In the example of FIG. 5, an input X has a dimension d. An output h is obtained by preprocessing input x through a linear layer containing pre-trained weights W as well as additional adapter linear layers containing weight matrices A and B, each having rank r. Although adapter layers in this example are linear layers, adapter convolutions are also possible where the rank r corresponds to a reduced number of channels. The additional weights are fine-tuned with initial values set to zero for B, and the normal distribution with a mean of zero for A.

Although adapters, such as LoRA, are efficient at retraining networks with good results, rapid switching of adapters is not efficient. A user may elect to switch adapters quickly on a device with limited resources. For example, if application developers want users to quickly experiment with various image styles, rapidly changing adapters on-device would be specified. Unfortunately, large latencies result from rapid adapter switching, particularly when LoRA is used in the fused mode.

Generative AI models are very large. For example, some image generators have 1.5 billion parameters, and some large language models have 7 billion parameters. Switching all weights whenever an adapter change would incur a massive inference latency. Alternatively, keeping the adapter unfused would also incur latency overhead from extra operations, thereby defeating the fusing benefit of techniques such as LoRA.

FIG. 6 is a block diagram illustrating multi-adapter low rank adaptation (LoRA) of a generative artificial intelligence (AI) model. In the example of FIG. 6, multiple LoRA adapters (LoRAα, LoRAβ, . . . LoRAγ) are shown, each resulting in a different set of adapter weights (w_{1,}w₂, . . . w_{N}). When a second LoRA adapter (e.g., LoRA β) is employed, the weights (e.g., w₂) from that second adapter (e.g., LoRA β) overwrite another set of weights (e.g., w₁) from another adapter (e.g., LoRA α.)

One approach for reducing the computations for adapting large scale models such as large language models is parameter-efficient fine-tuning (PEFT). PEFT involves fine-tuning a pre-trained model by identifying and adjusting only a small subset of the parameters of the pre-trained model that are most relevant to a specific task.

As described, aspects of the present disclosure are directed to layer-wise progressive thresholding. In accordance with various aspects of the present disclosure, parameter-efficient fine-tuning (PEFT) may be employed with a learned predictor attached. The learned predictor may be jointly trained with the original model. PEFT involves fine-tuning a pre-trained model by identifying and adjusting only a small subset of the parameters of the pre-trained model that are most relevant to a specific task. All parameters in a feed-forward (FF) network of an LLM and the predictor may be frozen. An initial threshold of the predictor may be set to a value that is less than 0.5 (e.g., 0.2) for each layer. Notably, the predictor parameters do not change, rather the threshold may be changed such that more elements may be activated. A low rank adapter (LoRA) only uses elements predicted to be valid during fine-tuning. During fine-tuning, a predicted mask may be randomly turned on/off following its probability.

During fine-tuning, for each training step (e.g., iteration), a layer of the predictor may be selected and the threshold may gradually increase (e.g., the threshold may increase from 0.2 to 0.3 in a subsequent training step) until overall computation cost reaches a pre-defined target.

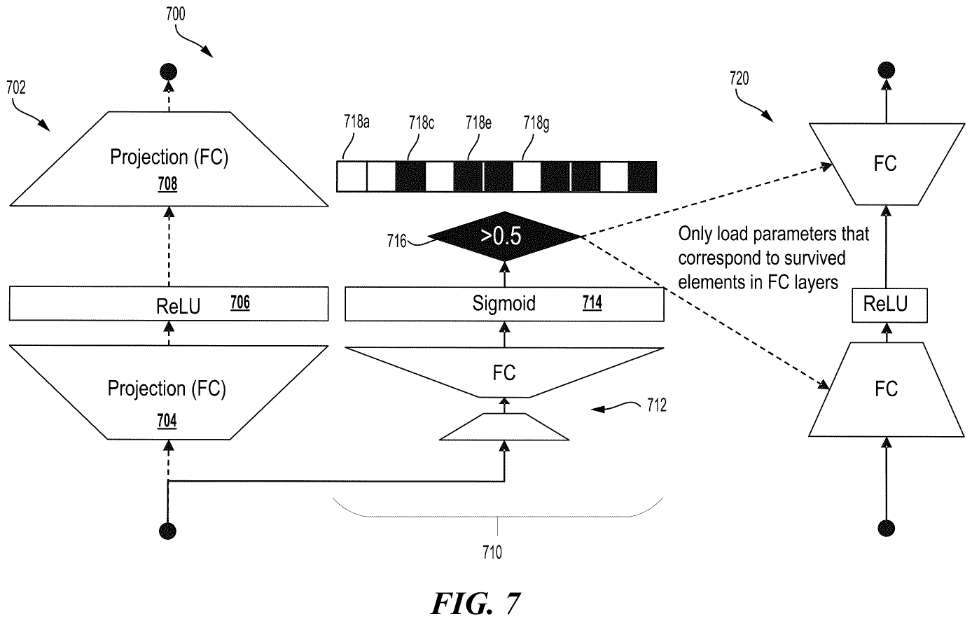

FIG. 7 is a block diagram illustrating an example architecture 700 for dynamic sparsity-aware PEFT of an LLM, in accordance with various aspects of the present disclosure. Referring to FIG. 7, the example architecture 700 may include an original feed-forward (FF) layer 702 and a predictor 710. The original FF layer 702 may, for instance comprise a feed-forward network (FFN) (e.g., 374 of FIG. 3B) of a transformer encoder block (e.g., 370 of FIG. 3B) of an LLM. The original FF layer 702 may include an up-projection 704, a ReLU 706, and a down-projection 708.

The predictor 710 may serve as an auxiliary network to adapt the sparsity. The predictor 710 may include a low rank bottleneck layer 712, a sigmoid function 714, and a threshold 716. The predictor 710 may indicate zero elements of a resulting FF layer 720 (e.g., of a LoRA applied to the original FF layer 702). The input of the original FF layer 702 may pass through the low rank bottleneck layer 712. The sigmoid function 714 may be applied to the output of the low rank bottleneck layer 712 to generate a score. The score may have a value in the range of zero to one. The score may be compared to the threshold value (e.g., 0.5) to determine which parameter values may be active and which values may be zero. If the value of an element of the score is above the threshold value, the parameters corresponding to that element may be active. On the other hand, if the value of an element of the score is below the threshold value, the parameter corresponding to that element may be zero (e.g., inactive). The threshold may initially be set to a value less than 0.5 (e.g., 0.2). A lower threshold value may permit more parameter values to be active initially. In doing so, more of the original FF parameters may be loaded from memory so the accuracy of a model with increased sparsity may be closer to that of the original FF layer 702. Accordingly, parameters of a low rank adapter may be configured to effectively cause parameters of the original FF layer 702 corresponding active elements to be loaded into memory (e.g., 118 of FIG. 1) effectively producing the resulting FF layer 720.

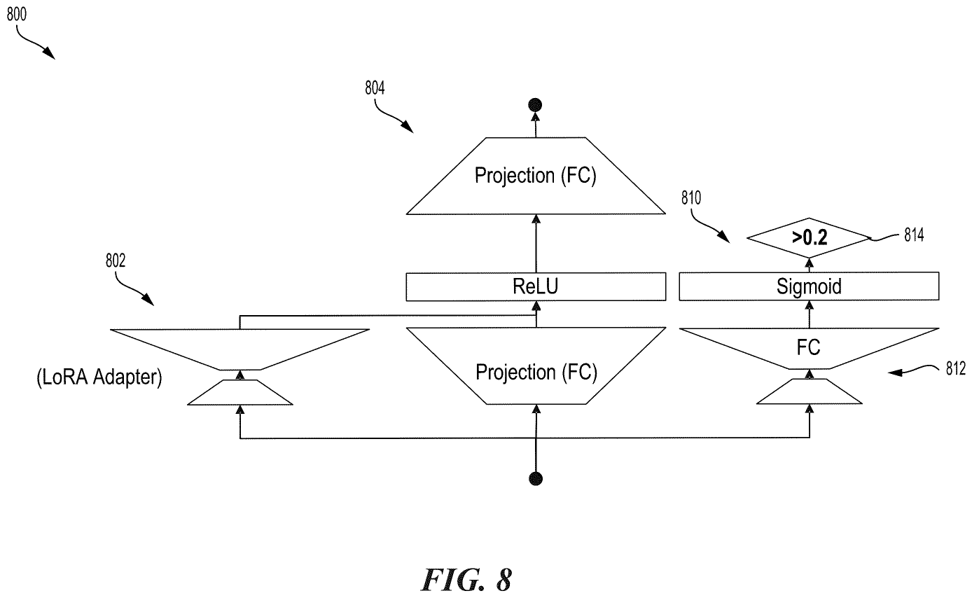

FIG. 8 is a block diagram illustrating an example architecture 800 for dynamic sparsity-aware PEFT of an LLM, in accordance with various aspects of the present disclosure. Referring to FIG. 8, the example architecture 800 is similar to the example architecture 700 and further illustrates a low rank adapter (LoRA) 802. Although only one LoRA 802 and one predictor 810 are shown, it should be understood that the example architecture 800 may include a low rank adapter 802 and a predictor 810 for a corresponding original FF layer 804 layer of an LLM.

The original FF layer 804 may comprise a portion of an artificial neural network that may be received by the example architecture 800. The original FF layer may have a set of pretrained weights. In some aspects, the example architecture 800 may also receive one or more adapters such as low rank adapter 802, for instance.

In accordance with various aspects of the present disclosure, thresholds 814 for one or more of the predictors 810 may be set to a value that is less than 0.5 (e.g., 0.1 or 0.2). In some aspects, all of the thresholds 814 may be set to the same value that is less than 0.5 (e.g., 0.2). Each of the predictors 810 may receive an input for the original FF layer 804. The input may be processed using a low rank bottleneck layer 812. A sigmoid function may be applied to output of the low rank bottleneck layer 812 to generate a score. The score may then be compared to the threshold 814 to determine whether elements of the score are active or inactive (zero). The corresponding parameters for the elements of the LoRA 802 may be determined to be active or inactive (e.g., set to zero). In this way, the predictor may provide an indication of the relative importance of corresponding parameters in maintaining the accuracy of the original model (e.g., with all parameters loaded into memory).

Then having determined the parameters of the LoRA 802 that are enabled and loaded into memory, the LoRA 802 for each layer may be fine-tuned. Each of the LoRAs 802 may use only elements determined (e.g., predicted) to be active during the fine-tuning. Additionally, the parameters of the original FF layer 804 and the predictor 810 may be fixed or frozen during the fine-tuning.

In some aspects, the predicted mask may be randomly turned on or off following its probability. During inference, parameter activation may be determined to be active or inactive based on the element score. If the element score is greater than the threshold (e.g., 814), the corresponding parameter for the element may be active and may otherwise be inactive. However, during fine-tuning, the parameter activation may be relaxed by applying some stochastic (randomized) behavior. For example, if the threshold is 0.3 and the predicted score is 0.25 (e.g., lower than the threshold but the gap is small), the parameter for the element may be randomly turned-on even if the score is less than the threshold. The larger the gap, the probability for the decision to be flipped decreases. If the threshold is 0.3 and the predicted score is 0.99 (e.g., higher than the threshold and the gap is large), it may be very unlikely to be turned-off during training. Accordingly, the random behavior may improve the model robustness by facing some noise during training.

Having completed the fine-tuning, the performance with the LoRA 802 (with the adapted sparsity by zeroing parameters corresponding to inactive elements of the predictor score) may be compared to a pre-defined target threshold value. The predefined target threshold may, for instance, correspond to an overall computation cost, an accuracy, inference latency, or other performance metric. If the pre-defined target threshold has not reached, the progressive thresholding (e.g., progressively increasing the threshold value) may continue.

During a next iteration, the threshold 814 for the predictor 810 for a layer may be selected. In some aspects, the layer may be selected sequentially, randomly, by lowest threshold, most effective, or by other selection criteria, for example.

Effectiveness, for purposes of layer selection, may be measured in multiple ways. For example, a selection may be according to the layer that gives the most performance improvement when the layer is selected (e.g., threshold of the layer is increased). In other words, a greedy strategy may be employed to get the most performance improvement for each iteration. For instance, a layer that newly de-activates the largest number of elements if the threshold of the layer is increased may be selected.

For the selected layer, the threshold 814 may be gradually increased (e.g., increased from 0.2→0.3). Then, input may be supplied to the low rank bottleneck layer 812 and the original FF layer 804. The output of the low rank bottleneck layer 812 may be subjected to a sigmoid function to generate a score. The elements of the score may be compared to the threshold (e.g., 0.3) to determine active and/or inactive elements. In turn corresponding parameters of the LoRA 802 may be set to zero or deemed active (e.g., values for active parameters may be maintained). In turn, the progressive thresholding and fine-tuning process may repeat until an overall computation cost satisfies a target threshold. In some aspects, the progressive thresholding and fine-tuning may repeat until the final performance does not increase from further increasing the threshold. The learned parameters of LoRA 802 and final threshold values may be saved and used for inference.

In some aspects, multiple LoRAs for different tasks may be employed. The parameters for each of the LoRAs for respective tasks may be separately learned in a similar manner.

By gradually increasing the threshold 814 for the predictor 810 from a lower value (e.g., 0.2) to a higher value (e.g., 0.3 or 0.4), the sparsity of the LoRA 802 may be adapted, effectively gradually reducing the parameters loaded in memory. In this way, a tradeoff between the memory footprint/latency and accuracy may be managed.

Moreover, implementing per-layer threshold selection may enable fine-grained control over LoRA sparsity as well as the tradeoff. Rather than controlling the threshold of an entire network together, aspects of the present disclosure enable the model to take advantage of the different sensitivities that different layers (of the LLM or the LoRA) may have to sparsity. Furthermore, adding randomness in the predicted mask (also referred to as a “binary mask”) may increase robustness of the overall model (e.g., including the LoRA and the LLM).

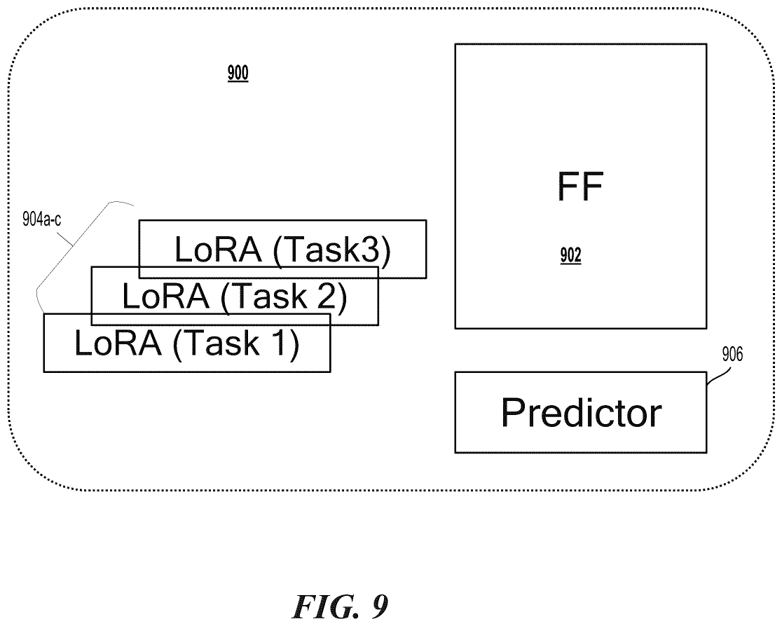

FIG. 9 is a block diagram illustrating an example device 900 for dynamic sparsity-aware PEFT of an LLM in accordance with various aspects of the present disclosure. As shown in FIG. 9, the device 900 may integrate FF parameters (e.g., millions of parameters) 902, multiple LoRAs (each for a different task) 904a-cand a predictor module 906 (including a lightweight predictor for each layer of the LoRA). Only the LoRA (e.g., 904a-c) and the corresponding predictor threshold are changed for the each of the different tasks. The FF parameters 902 and predictor module parameters are shared across the different tasks (e.g., 904a-c).

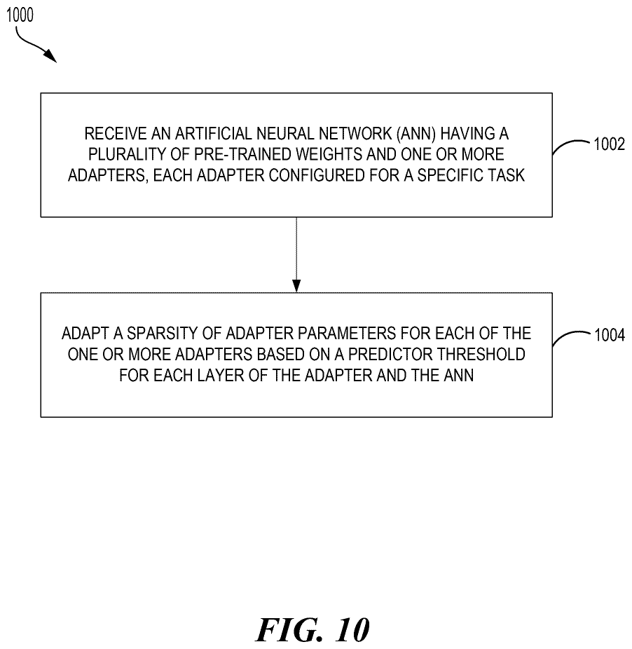

FIG. 10 is a flow diagram illustrating a processor-implemented method 1000 for implementing sparse adapters, in accordance with various aspects of the present disclosure. The processor-implemented method 1000 may be performed by one or more processors such as the CPU (e.g., 102, 422), GPU (e.g., 104, 426), and/or other processing unit (e.g., DSP 424, NPU 428).

As show in FIG. 10, at block 1002, the one or more processors receive an artificial neural network (ANN) having a plurality of pre-trained weights and one or more adapters. Each adapter is configured for a specific task. As described, for instance with reference to FIG. 8, the original FF layer 804 may comprise a portion of an artificial neural network that may be received by the example architecture 800.

The original FF layer may have a set of pretrained weights. In some aspects, the example architecture 800 may also receive one or more adapters such as low rank adapter 802, for instance.

At block 1004, the one or more processors adapt a sparsity of adapter parameters for each of the one or more adapters based on a predictor threshold for each layer of the adapter and the ANN. For example, with reference to FIG. 8, thresholds 814 for one or more of the predictors 810 may be set to a value that is less than 0.5 (e.g., 0.1 or 0.2). Each of the predictors 810 may receive an input for the original FF layer 804. The input may be processed using a low rank bottleneck layer 812. A sigmoid function may be applied to output of the low rank bottleneck layer 812 to generate a score. The score may then be compared to the threshold 814 to determine whether elements of the score are active or inactive (zero). The corresponding parameters for the elements of the LoRA 802 may be determined to be active or inactive (e.g., set to zero). In this way, the predictor may provide an indication of the relative importance of corresponding parameters in maintaining the accuracy of the original model (e.g., with all parameters loaded into memory). Then having determined the parameters of the LoRA 802 that are enabled (e.g., active) and loaded into memory, the LoRA 802 for each layer may be fine-tuned. Each of the LoRAs 802 may use only elements determined (e.g., predicted) to be active during the fine-tuning.

### EXAMPLE ASPECTS

Aspect 1: An apparatus, comprising: at least one memory; and at least one processor coupled to the at least one memory, the at least one processor configured to: receive an artificial neural network (ANN) having a plurality of pre-trained weights and one or more adapters, each adapter configured for a specific task; and adapt a sparsity of adapter parameters for each of the one or more adapters based on a predictor threshold for each layer of the adapter and the ANN.

Aspect 2: The apparatus of Aspect 1, wherein the at least one processor is further configured to set the predictor threshold for each layer to a first threshold value less than 0.5, the sparsity of the adapter parameters being iteratively adapted by progressively increasing a value for the predictor threshold corresponding to at least one layer of each adapter based on a performance metric.

Aspect 3: The apparatus of Aspect 1 or 2, wherein the at least one processor is further configured to select the at least one layer for progressively increasing the value of the predictor threshold.

Aspect 4: The apparatus of any preceding Aspect, wherein the at least one processor is further configured to: set a subset of the adapter parameters for an adapter layer to zero based on the predictor threshold for the adapter layer, remaining non-zero adapter parameters for the adapter layer forming a set of active adapter parameters for the adapter layer; and fine-tune only the set of active adapter parameters to form an updated adapter.

Aspect 5: The apparatus of any preceding Aspect, wherein predictor parameters and ANN parameters are fixed during fine-tuning.

Aspect 6: The apparatus of any preceding Aspect, wherein a predicted mask corresponding to the predictor threshold is randomly enabled during fine-tuning according to a predictor probability.

Aspect 7: A processor-implemented method performed by one or more processors, the processor-implemented method comprising: receiving an artificial neural network (ANN) having a plurality of pre-trained weights and one or more adapters, each adapter configured for a specific task; and adapting a sparsity of adapter parameters for each of the one or more adapters based on a predictor threshold for each layer of the adapter and the ANN.

Aspect 8: The processor-implemented method of Aspect 7, further comprising setting the predictor threshold for each layer to a first threshold value less than 0.5, the sparsity of the adapter parameters being iteratively adapted by progressively increasing a value for the predictor threshold corresponding to at least one layer of each adapter based on a performance metric.

Aspect 9: The processor-implemented method of Aspect 7 or 8, further comprising selecting the at least one layer for progressively increasing the value of the predictor threshold.

Aspect 10: The processor-implemented method of any of Aspects 7-9, further comprising: setting a subset of the adapter parameters for an adapter layer to zero based on the predictor threshold for the adapter layer, remaining non-zero adapter parameters for the adapter layer forming a set of active adapter parameters for the adapter layer; and fine-tuning only the set of active adapter parameters to form an updated adapter.

Aspect 11: The processor-implemented method of any of Aspects 7-10, wherein predictor parameters and ANN parameters are fixed during fine-tuning.

Aspect 12: The processor-implemented method of any of Aspects 7-11, wherein a predicted mask corresponding to the predictor threshold is randomly enabled during fine-tuning according to a predictor probability.

Aspect 13: An apparatus, comprising: means for receiving an artificial neural network (ANN) having a plurality of pre-trained weights and one or more adapters, each adapter configured for a specific task; and means for adapting a sparsity of adapter parameters for each of the one or more adapters based on a predictor threshold for each layer of the adapter and the ANN.

Aspect 14: The apparatus of Aspect 13, further comprising means for setting the predictor threshold for each layer to a first threshold value less than 0.5, the sparsity of the adapter parameters being iteratively adapted by progressively increasing a value for the predictor threshold corresponding to at least one layer of each adapter based on a performance metric.

Aspect 15: The apparatus of Aspect 13 or 14, further comprising means for selecting the at least one layer for progressively increasing the value of the predictor threshold.

Aspect 16: The apparatus of any of Aspects 13-15, further comprising: means for setting a subset of the adapter parameters for an adapter layer to zero based on the predictor threshold for the adapter layer, remaining non-zero adapter parameters for the adapter layer forming a set of active adapter parameters for the adapter layer; and means for fine-tuning only the set of active adapter parameters to form an updated adapter.

Aspect 17: The apparatus of any of Aspects 13-16, wherein predictor parameters and ANN parameters are fixed during fine-tuning.

Aspect 18: The apparatus of any of Aspects 13-17, wherein a predicted mask corresponding to the predictor threshold is randomly enabled during fine-tuning according to a predictor probability.

In one aspect, the receiving means, adapting means, setting means and/or fine-tuning means may be the CPU 102, GPU 104 or NPU 108, program memory associated with the CPU 102, GPU 104 or NPU 108, fully connected layers 362, and/or the routing connection processing unit 216 configured to perform the functions recited. In another configuration, the aforementioned means may be any module or any apparatus configured to perform the functions recited by the aforementioned means.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database, or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media.

The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor.

When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. An apparatus, comprising:
at least one memory; and
at least one processor coupled to the at least one memory, the at least one processor configured to:
receive an artificial neural network (ANN) having a plurality of pre-trained weights and one or more adapters, each adapter configured for a specific task; and
adapt a sparsity of adapter parameters for each of the one or more adapters based on a predictor threshold for each layer of the adapter and the ANN.

2. The apparatus of claim 1, wherein the at least one processor is further configured to set the predictor threshold for each layer to a first threshold value less than 0.5, the sparsity of the adapter parameters being iteratively adapted by progressively increasing a value for the predictor threshold corresponding to at least one layer of each adapter based on a performance metric.

3. The apparatus of claim 2, wherein the at least one processor is further configured to select the at least one layer for progressively increasing the value of the predictor threshold.

4. The apparatus of claim 1, wherein the at least one processor is further configured to:
set a subset of the adapter parameters for an adapter layer to zero based on the predictor threshold for the adapter layer, remaining non-zero adapter parameters for the adapter layer forming a set of active adapter parameters for the adapter layer; and
fine-tune only the set of active adapter parameters to form an updated adapter.

5. The apparatus of claim 4, wherein predictor parameters and ANN parameters are fixed during fine-tuning.

6. The apparatus of claim 4, wherein a predicted mask corresponding to the predictor threshold is randomly enabled during fine-tuning according to a predictor probability.

7. A processor-implemented method performed by one or more processors, the processor-implemented method comprising:
receiving an artificial neural network (ANN) having a plurality of pre-trained weights and one or more adapters, each adapter configured for a specific task; and
adapting a sparsity of adapter parameters for each of the one or more adapters based on a predictor threshold for each layer of the adapter and the ANN.

8. The processor-implemented method of claim 7, further comprising setting the predictor threshold for each layer to a first threshold value less than 0.5, the sparsity of the adapter parameters being iteratively adapted by progressively increasing a value for the predictor threshold corresponding to at least one layer of each adapter based on a performance metric.

9. The processor-implemented method of claim 8, further comprising selecting the at least one layer for progressively increasing the value of the predictor threshold.

10. The processor-implemented method of claim 7, further comprising:
setting a subset of the adapter parameters for an adapter layer to zero based on the predictor threshold for the adapter layer, remaining non-zero adapter parameters for the adapter layer forming a set of active adapter parameters for the adapter layer; and
fine-tuning only the set of active adapter parameters to form an updated adapter.

11. The processor-implemented method of claim 10, wherein predictor parameters and ANN parameters are fixed during fine-tuning.

12. The processor-implemented method of claim 10, wherein a predicted mask corresponding to the predictor threshold is randomly enabled during fine-tuning according to a predictor probability.

13. An apparatus, comprising:
means for receiving an artificial neural network (ANN) having a plurality of pre-trained weights and one or more adapters, each adapter configured for a specific task; and
means for adapting a sparsity of adapter parameters for each of the one or more adapters based on a predictor threshold for each layer of the adapter and the ANN.

14. The apparatus of claim 13, further comprising means for setting the predictor threshold for each layer to a first threshold value less than 0.5, the sparsity of the adapter parameters being iteratively adapted by progressively increasing a value for the predictor threshold corresponding to at least one layer of each adapter based on a performance metric.

15. The apparatus of claim 14, further comprising means for selecting the at least one layer for progressively increasing the value of the predictor threshold.

16. The apparatus of claim 13, further comprising:
means for setting a subset of the adapter parameters for an adapter layer to zero based on the predictor threshold for the adapter layer, remaining non-zero adapter parameters for the adapter layer forming a set of active adapter parameters for the adapter layer; and
means for fine-tuning only the set of active adapter parameters to form an updated adapter.

17. The apparatus of claim 16, wherein predictor parameters and ANN parameters are fixed during fine-tuning.

18. The apparatus of claim 16, wherein a predicted mask corresponding to the predictor threshold is randomly enabled during fine-tuning according to a predictor probability.
